(19) United States
(12) Patent Application Publication
(10) Pub. No.: US 2006/0050211 A1
(43) Pub. Date: Mar. 9, 2006

(54) Semi-transmission LCD device and method of making the same

(76) Inventors: Seong-ho Kim, Yongin-si (KR); Seung-gon Kang, Hwaseong-gun (KR); Chun-gi You, Hwaseong-gun (KR)

Correspondence Address: Cantor Colburn LLP, 55 Griffin Road South, Bloomfield, CT, 06002, US

(21) Appl. No.: 11/208,917

(22) Filed: Aug. 22, 2005

(30) Foreign Application Priority Data
Aug. 23, 2004 (KR) 2004-66490

(51) Int. Cl. G02F 1/1335; G02F 1/136

(52) U.S. Cl. 349/114; 349/42

(57) ABSTRACT

A liquid crystal display device includes a first substrate and a second substrate opposing the first substrate. The first substrate has a reflecting area and a transmitting area. The first substrate includes a first insulating substrate, a polysilicon layer disposed at the first insulating substrate and having a channel area, a gate wiring comprising a gate electrode positioned on the channel area, a source area and a drain area wherein the source area and the drain area are separated each other by the channel area, a data wiring comprising a source electrode and a drain electrode electrically connected with the source area and the drain area, respectively, an organic layer disposed at the data wiring, a reflecting layer disposed at the organic layer and defining the reflecting area, a color filter layer disposed at the reflecting layer, and a pixel electrode layer disposed at the color filter layer and electrically connected with the drain electrode.

This application claims priority to Korean Patent Application No. 2004-0066490, filed Aug. 23, 2004, and all the benefits accruing therefrom under 35 U.S.C §119, and the contents of which in its entirety are herein incorporated by reference.

### BACKGROUND OF THE INVENTION

1. Field of the Invention

The present invention relates to a semi-transmission liquid crystal display (LCD) device, and more particularly, to a semi-transmission LCD device in which a color filter layer and a thin film transistor are provided in the same substrate.

2. Description of the Related Art

An LCD device comprises a liquid crystal panel, which includes a thin film transistor (TFT) substrate, a color filter substrate and a liquid crystal layer disposed between the TFT substrate and the color filter substrate. Since the liquid crystal panel cannot emit light itself, a backlight unit may be located behind the TFT substrate to provide light to the liquid crystal panel. A transmittance of light from the backlight unit depends on an alignment of liquid crystal molecules in the liquid crystal layer.

In addition, the LCD device may further comprise a drive integrated circuit, a data driver, and a gate driver to drive a pixel. The data driver and the gate driver receive a driving signal from the drive integrated circuit and then apply a driving voltage on a data line and a gate line, respectively, within a display area of the LCD device.

LCD devices may be classified as either transmission type LCD devices or reflection type LCD devices according to a type of light source employed. A transmission type LCD device is a common type in which the backlight unit is located behind the liquid crystal panel and light from the backlight unit transmits through the liquid crystal panel. The transmission type LCD device has a disadvantage in that it is heavy, thick and consumes relatively large amounts of power. A reflection type LCD device reflects light from an exterior of the reflection type LCD device. Thus the reflection type LCD device can restrict use of the backlight unit, which accounts for up to 70% of power consumed by a typical LCD device. Due to the reflection type LCD device having a low power consumption, low weight and thin design, the reflection type LCD device has become popular for use in portable communication apparatuses.

Meanwhile, a semi-transmission type LCD device, which combines merits of the transmission type LCD device and the reflection type LCD device, can provide light having a suitable brightness to the liquid crystal panel regardless of a brightness of the exterior. A backlight unit of the semi-transmission type LCD device is used when exterior light is deficient, for example, in indoor environment. The semi-transmission type LCD device does not use the backlight unit when exterior light is sufficient, for example, in a high-illumination environment.

Meanwhile, amorphous silicon is generally used as a channel area of the TFT. A mobility of amorphous silicon is about 0.5˜1 cm²/Vsec, which is acceptable to be used in a switching device of an LCD device, but inappropriate to be used in a drive circuit formed directly on a liquid crystal panel.

To overcome this problem, a polysilicon TFT having a channel area formed with polysilicon having mobility of about 20˜150 cm²/Vsec has been developed. The polysilicon TFT having a higher mobility enables the drive circuit to be provided directly on the liquid crystal panel, which is called chip-on-glass.

If an LCD device using polysilicon as a channel area is manufactured as a semi-transmission type device, the LCD device may have both merits of the polysilicon and semi-transmission type. However, in making such an LCD device, an align margin between the color filter substrate and the TFT substrate should be considered. A part of a transmitting area and a reflection area in the TFT substrate is sacrificed in considering the align margin, thus limiting transmissivity/reflectivity.

### SUMMARY OF THE INVENTION

Accordingly, it is an aspect of the present invention to provide a semi-transmission LCD device which is not in need of considering the align margin and thus has improved reflectivity and transmissivity.

It is another aspect of the present invention to provide a method of making a semi-transmission LCD device which is not in need of considering the align margin and thus has improved reflectivity and transmissivity.

Additional aspects and advantages of the invention will be set forth in part in the description which follows and, in part, will be obvious from the description, or may be learned by practice of the invention.

The foregoing and/or other aspects of the present invention can be achieved by providing an liquid crystal display device comprising a first substrate having a reflecting area and a transmitting area and a second substrate opposing the first substrate. The first substrate comprises a first insulating substrate, a polysilicon layer disposed at the first insulating substrate and having a channel area, a gate wiring comprising a gate electrode positioned on the channel area, a source area and a drain area wherein the source area and the drain area are separated from each other by the channel area, a data wiring comprising a source electrode and a drain electrode electrically connected with the source area and the drain area, respectively, an organic layer disposed at the data wiring, a reflecting layer disposed at the organic layer and defining the reflecting area, a color filter layer disposed at the reflecting layer, and a pixel electrode layer disposed at the color filter layer and electrically connected with the drain electrode.

According to an exemplary embodiment of the invention a substrate of an LCD device is presented. The substrate includes a first insulating substrate, a polysilicon layer disposed at the first insulating substrate and having a channel area, a gate wiring comprising a gate electrode positioned on the channel area, a source area and a drain area wherein the source area and the drain area are separated from each other by the channel area, a data wiring comprising a source electrode and a drain electrode electrically connected with the source area and the drain area, respectively, an organic layer disposed at the data wiring, a reflecting layer disposed at the organic layer and defining the reflecting area, a color filter layer disposed at the reflecting layer, and a pixel electrode layer disposed at the color filter layer and electrically connected with the drain electrode.

Another aspect of the invention can be achieved by providing a method of making a liquid crystal display device comprising a first substrate having a reflecting area and a transmitting area and a second substrate opposing the first substrate. The method comprises forming a polysilicon layer having a channel area, a source area and a drain area on a first insulating substrate, forming a gate wiring comprising a gate electrode disposed on the channel area, forming a data wiring comprising a source electrode and a drain electrode electrically connected to the source area and the drain area, respectively, forming an organic layer on the data wiring, forming a reflecting layer which defines the reflecting area on the organic layer, forming a color filter layer on the reflecting layer, forming a pixel electrode layer electrically connected with the drain electrode on the color filter layer, and forming a common electrode layer on a second insulating substrate. The source area and the drain area are separated from each other by the channel area.

### BRIEF DESCRIPTION OF THE DRAWINGS

These and other aspects and advantages of the present invention will become apparent and more readily appreciated from the following description of exemplary embodiments, taken in conjunction with the accompanying drawings of which:

FIG. 1 is a plan view showing a first substrate according to an exemplary embodiment of the present invention;

FIG. 2 is cross-sectional view of the first substrate, taken along line II-II of FIG. 1;

FIG. 3 is a cross-sectional view of a liquid crystal panel according to an exemplary embodiment of the present invention;

FIG. 4A through FIG. 4E are cross-sectional views showing a method of making the first substrate of FIG. 1 according to an exemplary embodiment of the present invention;

FIG. 5 is a cross-sectional view of a first substrate according to another exemplary embodiment of the present invention;

FIG. 6 is a cross-sectional view of a first substrate according to still another exemplary embodiment of the present invention.

### DETAILED DESCRIPTION OF THE INVENTION

Reference will now be made in detail to exemplary embodiments of the present invention, which are illustrated in the accompanying drawings, wherein like reference numerals refer to like elements throughout. The exemplary embodiments are described below in order to explain the present invention by referring to the figures.

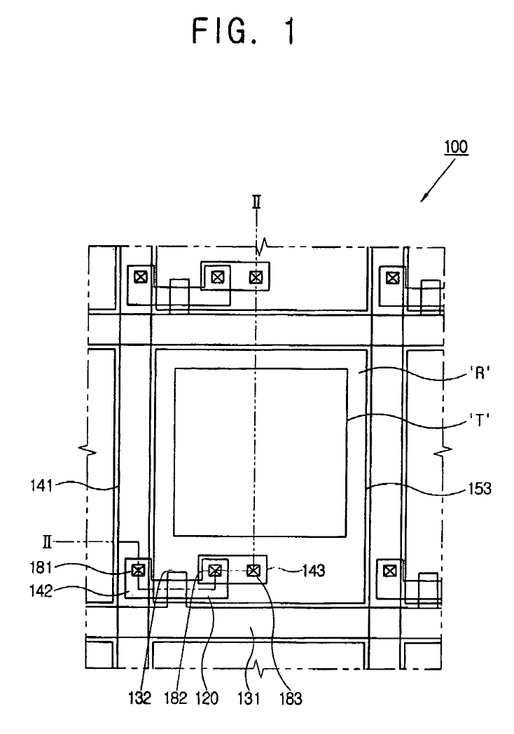

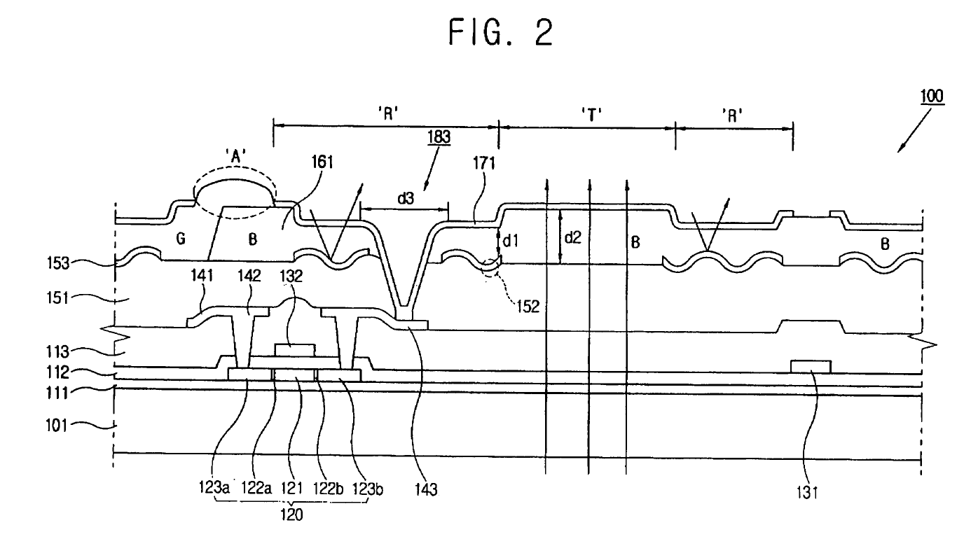

A first substrate according to an exemplary embodiment of the present invention will be explained with reference to FIG. 1 and FIG. 2.

FIG. 1 is a plan view showing a first substrate 100 according to an exemplary embodiment of the present invention and FIG. 2 is cross-sectional view of the first substrate 100, taken along line II-II of FIG. 1.

The first substrate 100 has a transmitting area T where light emitted from a backlight unit (not shown) transmits and a reflecting area R where light from an external source is reflected. The reflecting area R encloses or surrounds the transmitting area T.

A buffer layer 111 is disposed at a first insulating substrate 101 and a polysilicon layer 120 is disposed at the buffer layer 111. The first insulating substrate 101 is generally made with quartz or glass. The buffer layer 111 is generally made with silicon oxide and prevents an alkali metal of the first insulating substrate 101 from diffusing into the polysilicon layer 120.

The polysilicon layer 120 comprises a channel area 121, an LDD (lightly doped domain) area 122a and 122b which is divided into two parts while having the channel area 121 as a center between the two parts, and a source area 123a and a drain area 123b which are respectively located outside of the LDD area 122a and 122b. In other words, a first LDD area part 122a is disposed adjacent to a first side of the channel area 121 and the source area 123a is disposed opposite to the channel area 121 with respect to the first LDD area part 122a. A second LDD area part 122b is disposed adjacent to a second side of the channel area 121 that is opposite to the first side of the channel area 121. The drain area 123b is disposed opposite to the channel area 121 with respect to the second LDD area part 122b. The LDD area 122a and 122b is n− doped and disperses a hot carrier, while the channel area 121 is not doped by an impurity and the source/drain areas 123a and 123b are n+ doped.

A gate insulating layer 112 formed from silicon oxide or silicon nitride is disposed at the polysilicon layer 120. A gate electrode 132 is disposed at the gate insulating layer 112 over the channel area 121. In other words, the gate electrode 132 is disposed at a portion of the gate insulating layer 112 corresponding to the channel area 121.

The gate electrode 132 is extended from a gate line 131 and forms a gate wiring together with the gate line 131. The gate wiring (represented by the gate line 131 and the gate electrode 132) may be made with various metals, preferably AlNd.

An inter layer dielectric 113 covering the gate electrode 132 is disposed at the gate insulating layer 112. Contact holes 181 and 182 exposing the source area 123a and the drain area 123b, respectively, are formed through the gate insulating layer 112 and the inter layer dielectric 113. The inter layer dielectric 113 is generally made from a silicon oxide layer or silicon nitride layer, that is, for example, made of a double layer of the silicon nitride layer or the silicon oxide layer.

A source electrode 142 and a drain electrode 143 are connected to the source area 123a and the drain area 123b through the contact holes 181 and 182, respectively, and are disposed at the inter layer dielectric 113. The source electrode 142 and the drain electrode 143 face each other while having the gate electrode 132 as a center.

The source electrode 142 is a branch of a data line 141, which is disposed perpendicular to the gate line 131 and forms a pixel. Additionally, the source electrode 142 forms a data wiring with the data line 141 and the drain electrode 143.

The data wiring (represented by the data line 141, the source electrode 142 and the drain electrode 143) may be made with various metals, preferably MoW.

An organic layer 151 is formed on the data wiring and a portion of the inter layer dielectric 113 that is not covered by the drain wiring. The organic layer 151 is preferably made with benzocyclobutene or photo acryl. The organic layer 151 is not removed in the transmitting area T. A lens part 152, which enhances an efficiency of reflecting, is disposed at an upper part of the organic layer 151 positioned in the reflecting area R. In an exemplary embodiment, the lens part 152 is formed by shaping an upper surface of the organic layer 151 to have alternating convex and concave portions.

A reflecting layer 153 is disposed at the organic layer 151. The reflecting layer 153 defines the reflecting area R where light from the external source is reflected. Since the reflecting layer 153 is formed to have a shape of the lens part 152, the reflecting layer 153 has good efficiency of reflecting. The reflecting layer 153 is generally formed from metals having high reflectivity such as aluminum or alloys of aluminum. An additional example of such metals includes an alloy of silver, palladium and copper. The alloy generally comprises 98.1 wt. % of silver, 0.9 wt. % of palladium and 1 wt. % of copper and is not corroded by contact with ITO (indium tin oxide), which is widely used as a pixel electrode layer 171.

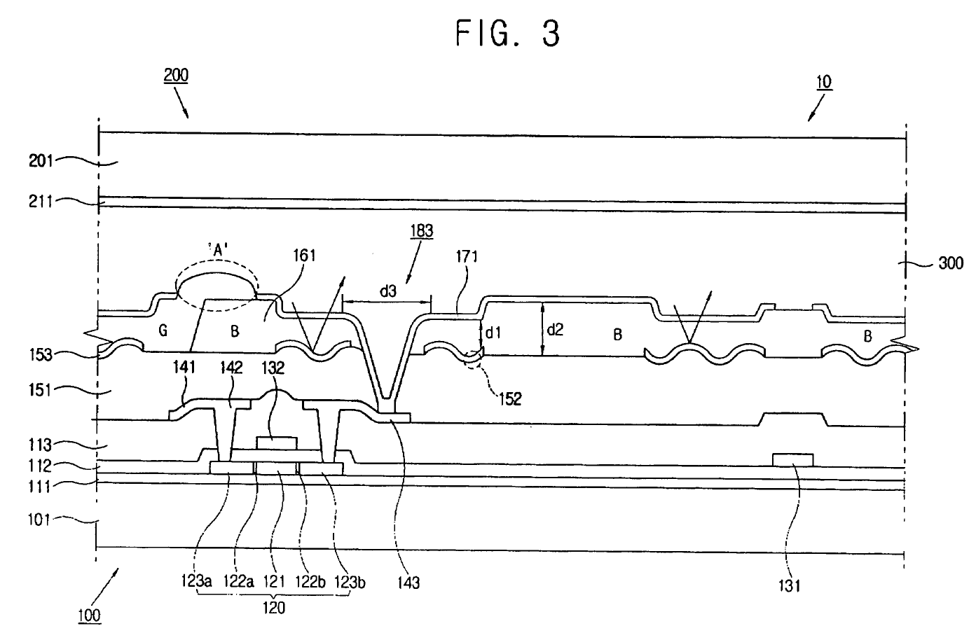

A color filter layer 161 is disposed at the reflecting layer 153 and portions of the organic layer 151 not covered by the reflecting layer 153. Light emitted to an exterior of an LCD device having the first substrate 100 via a liquid crystal layer 300 (see FIG. 3) is endowed with color by passing through the color filter layer 161. At each of the pixels, the color filter layer 161 has one color from among red, green and blue (RGB). In FIG. 2, portion ‘A’, which is located over the data line 151, is a portion of the color filter layer 161 in which two color filters are overlapped to function similarly to a black matrix. The organic layer 151, the reflective layer 153 and the color filter layer 161 over the drain electrode 143 are removed, thus forming a contact hole 183. To remove the organic layer 151, which is relatively thick having a thickness of about 2 μm, and the color filter layer 162 having a thickness of about 1 μm at a same place, an upper diameter d3 of the contact hole 183 is somewhat large.

Thickness d2 of the color filter layer 161 in the transmitting area T is larger than thickness d1 of the color filter layer 161 in the reflecting area R, which makes a color reproduction property uniform. Light from the backlight unit passes through the color filter layer 161 once, and then leaves to the exterior of the LCD device via the transmitting area T. However, light from the external source, which is reflected at the reflection area R and then leaves to the exterior of the LCD device, passes through the color filter layer 161 twice. Accordingly, the color reproduction property between the reflecting area R and the transmitting area T is different. To solve this problem, the thickness d2 of the color filter layer 161 in the transmitting area T is larger than the thickness d1 of the color filter layer 161 in the reflecting area R. For example, d1 is about the half of d2.

The pixel electrode layer 171 is disposed at the color filter layer 161. The pixel electrode layer 171 is formed from a transparent conductive material such as ITO or IZO (indium zinc oxide). The pixel electrode layer 171 applies voltage to the liquid crystal layer 300 together with a common electrode layer 211 of a second substrate 200, shown in FIG. 3. The pixel electrode layer 171 is connected to the drain electrode 143 through the contact hole 183, which is formed through the organic layer 151, the reflecting layer 153 and the color filter layer 161.

The reflecting layer 153 is disposed under the color filter layer 161 to make light reflected at the reflecting layer 153 pass through the color filter layer 161. Further, the pixel electrode layer 171 is disposed on the color filter layer 161 to directly apply voltage to the liquid crystal layer 300. The reflecting layer 153 is not connected with the pixel electrode layer 171. If the reflecting layer 153 is connected with the pixel electrode layer 171, a conductance may be formed because the color filter layer 161 disposed between the reflecting layer 153 and the pixel electrode layer 171 acts as a dielectric.

FIG. 3 is a cross-sectional view of a liquid crystal panel 10 according to an exemplary embodiment of the present invention.

The liquid crystal panel 10 comprises the first substrate 100, the second substrate 200 and the liquid crystal layer 300 disposed between the first and second substrates 100 and 200.

The second substrate 200, which is opposite to the first substrate 100 with respect to the liquid crystal layer 300, comprises a second insulating substrate 201 and the common electrode layer 211. The common electrode layer 211 contacts the second insulating layer 201 directly. The common electrode layer 211 is formed from a transparent conductive material such as ITO or IZO. The second substrate 200 has no black matrix or color filter layer 161, thereby making alignment of the first substrate 100 and the second substrate 200 free from align margin. Accordingly, a design and alignment of the first substrate 100 can be performed to make transmissivity and reflectivity high.

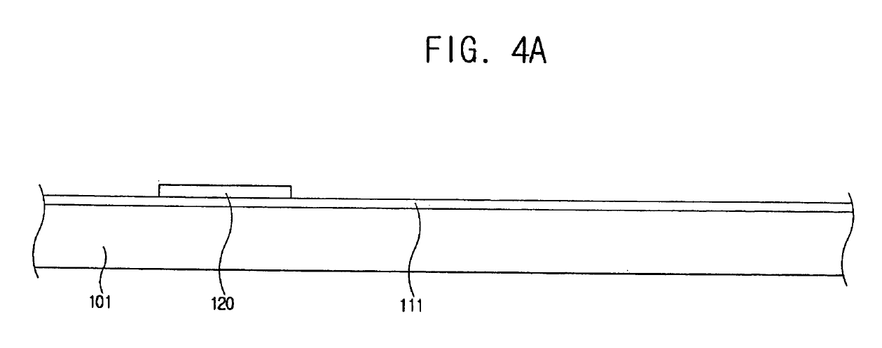

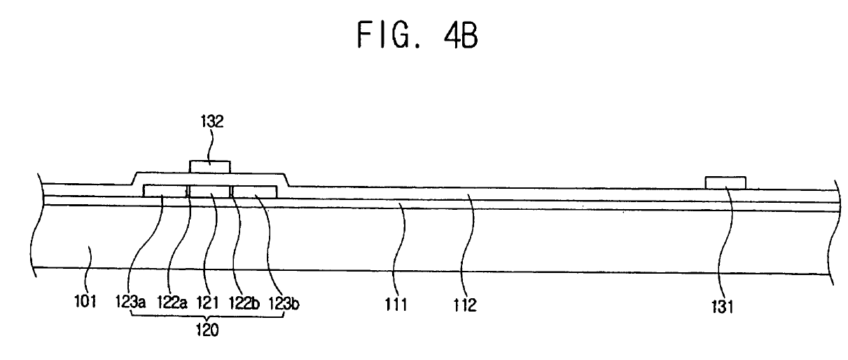

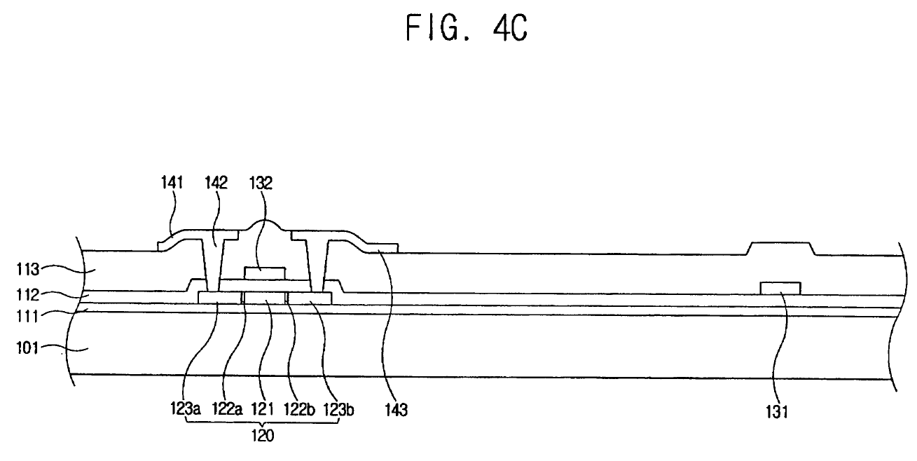

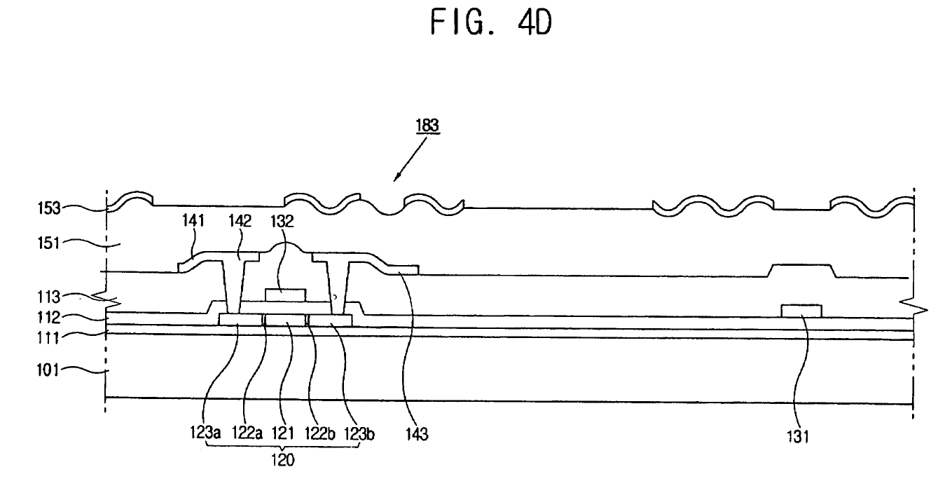

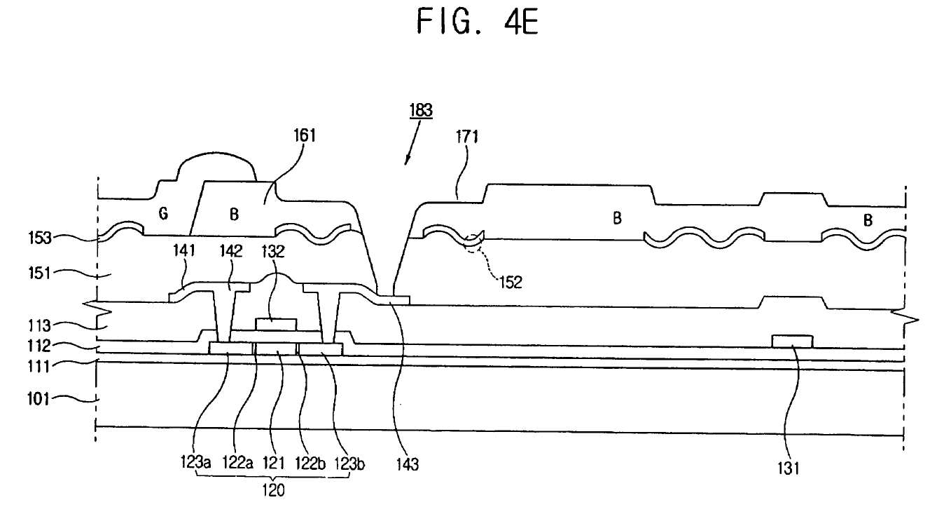

A method of making the first substrate of FIG. 1 according to an exemplary embodiment of the present invention will be explained with reference to FIG. 4A through FIG. 4E.

First, as shown in FIG. 4A, the buffer layer 111 is disposed at the insulating substrate 101. The polysilicon layer 120 is then disposed at the buffer layer 111. The buffer layer 111 is generally made with silicon oxide through chemical vapor deposition.

Exemplary methods of making the polysilicon layer 120 include depositing polysilicon directly on a substrate at high temperature, crystallizing a deposited amorphous silicon at a high temperature of about 600° C., eximer laser annealing (ELA), sequential laser annealing (SLA), and metal induced crystallization (MIC). In the present invention, any suitable method of making the polysilicon layer 120 may be employed.

Then, the gate insulating layer 112 is formed by depositing silicon oxide or silicon nitride, as shown in FIG. 4B. Then, a conductive material for gate wiring is deposited and patterned, thereby forming the gate wiring including the gate line 131 and the gate electrode 132. The channel area 121, the LDD area 122a and 122b and the source and drain areas 123a and 123b are formed by injecting n-type impurity into corresponding portions of the polysilicon layer 120 using the gate electrode 132 as a mask. A plurality of methods are available to make the LDD area 122a and 122b, for example, making an overhang through wet-etching of a double-layered gate electrode 132 can be used.

Then, as shown in FIG. 4C, the inter layer dielectric 113 covering the gate electrode 132 is disposed at the gate insulating layer 112. The inter layer dielectric 113 is patterned together with the gate insulating layer 112 to form the contact holes 181 and 182 exposing the source area 123a and the drain area 123b, respectively. Then, a conductive material for data wiring is deposited and patterned, thereby forming the source electrode 142 and the drain electrode 143 connected to the source area 123a and the drain area 123b through the contact holes 181 and 182, respectively, and the data line 141. In an exemplary embodiment, the inter layer dielectric 113 may be formed by sequential deposition of the silicon oxide and the silicon nitride.

Then, as shown in FIG. 4D, the organic layer 151 and the reflecting layer 153 are formed. The lens part 152 is formed at the upper part of the organic layer 151 through coating, exposing to light and curing of the organic layer 151. The lens part 152 is only disposed at the reflecting area R. The reflecting layer 153 deposited on the organic layer 151 is patterned to remain only at the reflecting area R. In other words, the reflecting layer 153 is only disposed on the lens part 152. Further, the reflecting layer 153 is removed at the contact hole 183 to allow the pixel electrode layer 171 to be connected to the drain electrode 143.

Then, the color filter layer 161 is formed, as shown in FIG. 4E. At each pixel, the color filter layer 161 has one color among RGB (red, green and blue). A color filter photoresist, which is a mixture of a photoresist and a pigment, may be used to form the color filter layer 161. The contact hole 183 is formed through exposing and developing of the color filter photoresist coated on the organic layer 151 using a mask. A difference of color filter layer 161 thicknesses between the transmitting area T and the reflecting area R can be adjusted by controlling a pattern of the mask. For example, ultraviolet may be irradiated to the color filter photoresist in the transmitting area T using a mask with a silt, while ultraviolet may be irradiated to the color filter photoresist in the reflecting area R using a mask without a pattern thus controlling the thickness of the color filter layer 161 as shown in FIG. 4E.

By depositing and patterning of the pixel electrode layer 171, the first substrate 100 is completed, as shown in FIG. 2. The pixel electrode layer 171 is connected to the drain electrode 143 through the contact hole 183, which is formed through the organic layer 151, the reflecting layer 153 and the color filter layer 161.

The second substrate 200 is formed by depositing the common electrode layer 211 on the second insulating substrate 201.

A sealant is drawn along a boundary of the first substrate 100, then a filling of the liquid crystal and adhering of the first substrate 100 and the second substrate 200 are performed. Since the second substrate 200 has no black matrix or color filter layer, a misalign problem in alignment of the first substrate 100 and the second substrate 200 does not occur. An aperture ratio can be improved due to absence of the black matrix from the second substrate 200. Furthermore, since light leakage from the misalign problem does not occur, a contrast ratio can be improved.

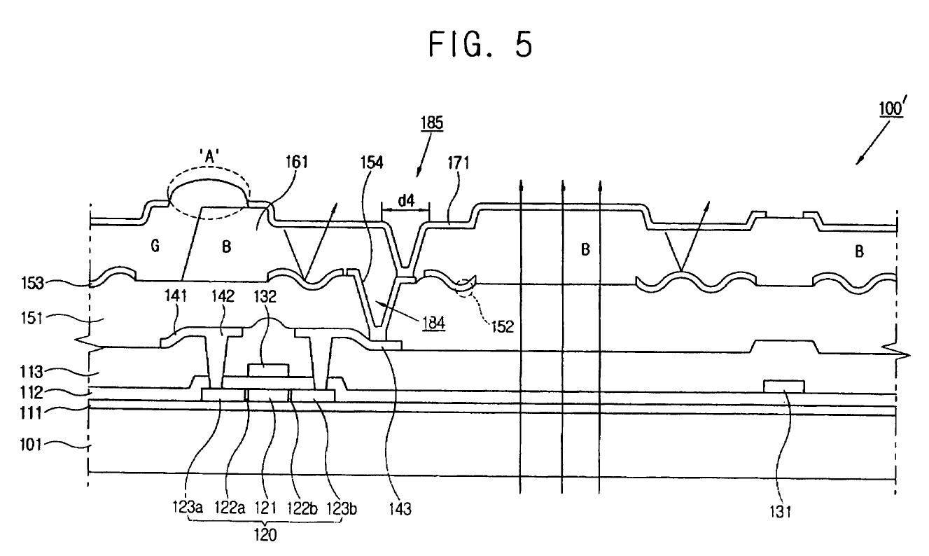

FIG. 5 is a cross-sectional view of a first substrate 100′ according to another exemplary embodiment of the present invention. A structure of this exemplary embodiment is substantially same as a structure of the exemplary embodiment of FIGS. 1-3, thus only those portions that are different will be explained in detail.

In this exemplary embodiment, the pixel electrode layer 171 is connected to the drain electrode 143 via a connecting reflecting layer 154. Thus, contact holes 184 and 185 are provided to connect the pixel electrode layer 171 to the drain electrode 143 via the connecting reflecting layer 154. The connecting reflecting layer 154 is electrically connected to the drain electrode 143 through the contact hole 184. The contact hole 184 is formed through the organic layer 151.

The connecting reflecting layer 154 is not electrically connected to the reflecting layer 153. The pixel electrode layer 171 is electrically connected to the connecting reflecting layer 154 through the contact hole 185, wherein the contact hole 185 is formed through the color filter layer 161. With this configuration, the diameter d4 of the contact hole 185 can be smaller than that of contact hole 183 of the exemplary embodiment of FIGS. 1-3, thus reflectivity is improved by decreasing an area of the contact hole 185.

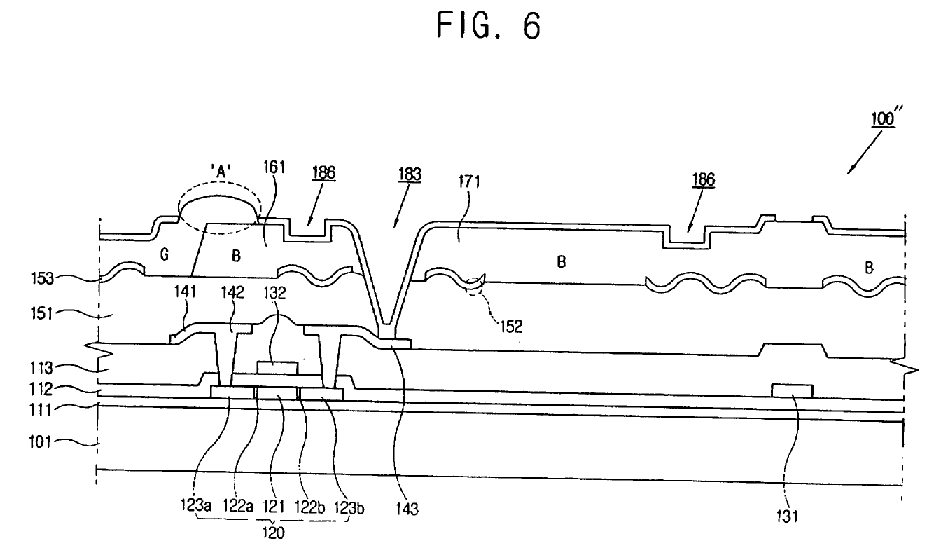

FIG. 6 is a cross-sectional view of a first substrate 100″ according to yet another exemplary embodiment of the present invention. A structure of this exemplary embodiment is substantially same as a structure of the exemplary embodiment of FIGS. 1-3, thus only those portions that are different will be explained in detail.

In this exemplary embodiment, the color filter layer 161 in the reflecting area R has a concave part 186. A difference of a color regeneration property between the transmitting area T and the reflecting area R is repressed by the concave part 186. The concave part 186 may be formed by adjusting the exposing of the color filter photoresist. The concave part 186 comprises, for example, a concavely formed recess portion in a surface of the color filter layer 161 that faces the second substrate 200.

A number, location, form, and depth of the concave part 186 may be various. However, it is not preferable that the color filter layer 161 is completely removed in the concave part 186 because the pixel electrode layer 171 may contact with the reflecting layer 153.

As described above, the present invention provides an LCD device using a polysilicon layer as a channel area and having improved transmissivity and reflectivity.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A liquid crystal display device comprising:
a first substrate having a reflecting area and a transmitting area and including:
a first insulating substrate;
a polysilicon layer disposed at the first insulating substrate and having a channel area, a source area and a drain area, the source area and the drain area being separated from each other by the channel area;
a gate wiring comprising a gate electrode positioned on the channel area;
data wiring comprising a source electrode and a drain electrode electrically connected to the source area and the drain area, respectively;
an organic layer disposed at the data wiring;
a reflecting layer disposed at the organic layer and defining the reflecting area;
a color filter layer disposed at the reflecting layer; and
a pixel electrode layer disposed at the color filter layer and electrically connected to the drain electrode; and
a second substrate having a common electrode layer thereon and disposed to face the first substrate.

2. The liquid crystal display device according to claim 1, wherein a thickness of the color filter layer in the transmitting area is larger than a thickness of the color filter layer in the reflecting area.

3. The liquid crystal display device according to claim 2, wherein the thickness of the color filter layer in the reflecting area is about one half of the thickness of the color filter layer in the transmitting area.

4. The liquid crystal display device according to claim 1, wherein the color filter layer in the reflecting area has a concave part.

5. The liquid crystal display device according to claim 1, wherein an upper part of the organic layer in the reflecting area is lens-shaped.

6. The liquid crystal display device according to claim 1, wherein an upper surface of the organic layer in the reflecting area comprises alternating concave and convex portions.

7. The liquid crystal display device according to claim 6, wherein the reflecting layer is disposed at the upper surface of the organic layer in the reflecting area to conform to a shape of the upper surface of the organic layer.

8. The liquid crystal display device according to claim 1, wherein the reflecting layer comprises silver, palladium and copper.

9. The liquid crystal display device according to claim 1, wherein the pixel electrode layer is directly connected with the drain electrode.

10. The liquid crystal display device according to claim 1, wherein the reflecting layer comprises a connecting reflecting layer which is directly connected with the drain electrode, and the pixel electrode is directly connected with the connecting reflecting layer.

11. The liquid crystal display device according to claim 1, wherein the second substrate comprises a second insulating substrate and the common electrode layer directly connected with the second insulating substrate.

12. The liquid crystal display device according to claim 1, wherein the color filter layer comprises adjacently disposed color filter portions which correspond to particular colors.

13. The liquid crystal display device according to claim 12, further comprising an overlap region where one of the adjacently disposed color filter portions overlaps another of the adjacently disposed color filter portions.

14. The liquid crystal display device according to claim 1, wherein the color filter layer comprises a concavely formed recess portion in a surface of the color filter layer that faces the second substrate, the recess portion being disposed at a portion of the color filter layer corresponding to the reflecting area.

15. A substrate for a liquid crystal display device, the substrate having a reflecting area and a transmitting area and including:
an insulating substrate;
a polysilicon layer disposed at the insulating substrate and having a channel area, a source area and a drain area, the source area and the drain area being separated from each other by the channel area;
a gate wiring comprising a gate electrode positioned on the channel area;
data wiring comprising a source electrode and a drain electrode electrically connected to the source area and the drain area, respectively;
an organic layer disposed at the data wiring;
a reflecting layer disposed at the organic layer and defining the reflecting area;
a color filter layer disposed at the reflecting layer; and
a pixel electrode layer disposed at the color filter layer and electrically connected to the drain electrode.

16. The substrate according to claim 15, wherein a thickness of the color filter layer in the transmitting area is larger than a thickness of the color filter layer in the reflecting area.

17. The substrate according to claim 15, wherein the reflecting layer comprises a connecting reflecting layer which is directly connected with the drain electrode, and the pixel electrode is directly connected with the connecting reflecting layer.

18. A method of making a liquid crystal display device comprising a first substrate having a reflecting area and a transmitting area and a second substrate opposing to the first substrate, the method comprising:
forming a polysilicon layer having a channel area, a source area and a drain area on a first insulating substrate of the first substrate, the source area and the drain area being separated from each other by the channel area;
forming a gate wiring comprising a gate electrode disposed corresponding to the channel area;
forming a data wiring comprising a source electrode and a drain electrode electrically connected with the source area and the drain area, respectively;
forming an organic layer on the data wiring;
forming a reflecting layer on the organic layer, the reflecting layer defining the reflecting area;
forming a color filter layer on the reflecting layer;
forming a pixel electrode layer on the color filter layer, the pixel electrode layer being electrically connected with the drain electrode; and
forming a common electrode layer on a second insulating substrate of the second substrate.

19. The method of making a liquid crystal display device according to claim 9, wherein the forming the color filter layer comprises forming a thickness of the color filter layer in the transmitting area to be larger than a thickness of the color filter layer in the reflecting area.

20. The method of making a liquid crystal display device according to claim 10, wherein the forming the color filter layer comprises employing a mask having a slit structure to form the color filter layer.
